(19) United States
(12) Patent Application Publication
(10) Pub. No.: US 2002/0092995 A1
(43) Pub. Date: Jul. 18, 2002

(54) Variable hydraulic valve drive

(76) Inventors: Michael Garstenauer, Linz (AT); Norbert Krimbacher, Linz (AT); Rudolf Scheidl, Erlauf (AT)

Correspondence Address: Anthony M. Lorusso, Lorusso & Loud, 440 Commercial Street, Boston, MA, 02109, US

(21) Appl. No.: 10/021,688

(22) Filed: Dec. 11, 2001

(30) Foreign Application Priority Data
Dec. 12, 2000 (AT) A 2062/2000

(51) Int. Cl. F16K 31/12

(52) U.S. Cl. 251/12

(57) ABSTRACT

A fully variable hydraulic valve drive comprising a hydraulic drive unit which is acted upon with hydraulic fluid for opening and closing a valve wherein the drive unit of the valve in the closing or opening stroke movement acts on an intermediate storage means with hydraulic fluid under pressure, wherein this hydraulic fluid which is stored under pressure in the intermediate storage means then drives the drive unit of the valve again in the opposite stroke movement.

The present invention concerns a fully variable hydraulic valve drive comprising a hydraulic drive unit which is acted upon with hydraulic fluid for opening and closing a valve wherein the drive unit of the valve in the closing or opening stroke movement acts on an intermediate storage means with hydraulic fluid under pressure.

Present day internal combustion engines increasingly involve active intervention into the operation of the engine. In that way it is possible to increase the level of efficiency and thus save on fuel and reduce pollutant emissions. One step in that direction is influencing the discharge of exhaust gas and the feed of fresh air or the feed of the gas mixture. In order to be able to implement an influence which is more far-reaching than the state of the art, in that area, it is necessary to be able to separately control each individual valve of an engine. In order to afford complete intervention in that part of the cycle process, it must be possible to vary as desired the opening durations, the opening times and the opening stroke movements of the individual valves. The invention is concerned with energy-efficient implementation of a fully variable valve drive of hydraulic nature.

There are a very wide range of different methods of implementing a variable valve drive. The individual methods can be subdivided into the following groups with the individual patent numbers belonging to such groups:

As examples of systems without a camshaft, involving an electrical operating principle, mention may be made of DE 330 707 070, U.S Pat. No. 4,375,793 and EP 0 390 519. A system without a camshaft involving a pneumatic operating principle is shown in DE 37 39 775 and U.S. Pat. No. 5,193,495. A system without a camshaft with a hydraulic operating principle is shown in DE 20 08 668, DE 39 09 822 A1, DE 38 33 459, DE 38 36 725, EP 0 19 376, WO 84/01651, U.S. Pat. No. 5,272,136 and U.S. Pat. No. 5,829,396. Systems based on a mechanical operating principle, without a camshaft, are shown in DE 20 06 618, DE 23 63 891, DE 24 28 915. DE 368 775, U.S. Pat. No. 4,231,130, DE 31 26 620, DE 33 26 096, DE 34 15 245, DE 38 00 347, DE 40 36 279, DE 36 21 080, DE 30 15 005, U.S. Pat. No. 5,103,779, DE 21 05 542 and DE 29 26 327.

Besides the above-indicated systems there also exist systems with a camshaft. These are on the one hand systems with a conventional camshaft. Here, there are various points of intervention into the variability of the valve drive by coupling hydraulics and mechanics, using a plurality of camshafts and so forth. In addition there exist systems with special camshafts. Here there are various locations of intervention into the variability of the valve drive by mechanical transmission assemblies. In summary there are a large number of patents which are concerned with systems with camshafts.

In implementing a variable valve drive with a magnetic drive, it is necessary to accept a high level of power demand and high development costs. It is also necessary to make provision for emergency operation of the engine in the event of a power failure, which is expensive. The power density of electromagnets is very low in comparison with hydraulics and implementation therefore takes up a great deal of space.

Pneumatic drives also require a high level of power. The power density is only immaterial greater in comparison with electromagnetic drives.

By virtue of their high level of power density hydraulic drives permit compact structures to be achieved. In the above-specified patents only a small part of the power supplied involves intermediate storage. Therefore those circuitry configurations require high levels of connection power. U.S. Pat. No. 5,272,136 is discussed in the specific description as representative of the state of the art. In the embodiment of a valve drive in accordance with that patent, partial energy recovery is achieved. A great problem with that arrangement however is that the hydraulic valves are opened and closed at the greatest valve speeds and thus with the greatest volume flows. As a result, by virtue of finite valve speeds, energy is converted into heat by throttle losses. In other patents the energy involved is not recovered at all. Those valve drives therefore involve a high power demand.

A further hydraulic valve drive with a pressure storage means is disclosed in DE 40 02 856 A1. Here the hydraulic medium which is recovered from a closing cylinder can however be used again for a working stroke movement only when a certain pressure in the storage means is attained.

Therefore the object of the invention is to provide a fully variable, specifically actuable hydraulic valve drive in which the energy once used in the valve drive is recovered almost completely and made available for the subsequent opening or closing cycle. A further object of this invention is to overcome the other disadvantages of the state of the art.

In accordance with the invention that is achieved in that this hydraulic fluid which is stored under pressure in the intermediate storage means then drives the drive unit of the valve again in the opposite stroke movement.

The present invention therefore describes a variant which recovers all the supplied energy (except for the frictional losses of the valve stem and the flow losses through the opened hydraulic valves) and recycles it in the next cycle. That greatly reduces the energy consumption involved. The remaining losses are determined primarily by the structural size, that is to say by the magnitude of the nominal volume flow (unit I/min) of a fast switching valve. The hydraulic drive unit often comprises a piston cylinder unit.

In the case of the fully variable hydraulic valve drive according to the invention the valve in the opening or closing stroke movement or in both stroke movements is accelerated and braked in the form of a free oscillator, wherein preferably a control valve holds the valve in the opened and closed condition. In that respect, as an approximation and disregarding the frictional losses, a freely swinging pendulum which is held fast at its extreme deflection limits can be referred to as a physical analogy. Along the lines of that analogy, it is in accordance with the condition of the pendulum when it is held at the position of maximum deflection and thus possesses maximum potential energy, in the case of the valve drive this being the condition when for example the valve is closed and thus the hydraulic fluid is stored in the intermediate storage means under pressure. When now the control valve between the intermediate storage means and the drive unit of the valve opens, that corresponds to the pendulum being released. After opening of the control valve the hydraulic fluid under pressure flows by way of the control valve into the cylinder of the drive unit of the valve and the valve is accelerated. In the analogy of the pendulum, that corresponds to the swinging movement. With an increasing amount of hydraulic fluid which is caused to flow from the intermediate storage means into the cylinder chamber of the valve drive unit, the resultant force on the drive unit of the valve decreases. That causes the valve to be decelerated. That corresponds to the pendulum when it has swung beyond the zero position and is being decelerated by the corresponding forces. Before the drive unit of the valve changes its direction of movement the control valve is closed and thus the drive unit is fixed in the other limit position. In the analogy, that corresponds to the condition when the pendulum has reached the second extreme position and is held fast there. If the control valve is now opened again, the opposite procedure begins.

As shown with the above-discussed analogy of the pendulum, the valve drive according to the invention implements an opening stroke movement and/or a closing stroke movement of the valve in a hydraulic system which is closed in that period of time. That hydraulic system preferably comprises an intermediate storage means, a drive unit of the valve and a control valve.

The variable valve drive according to the invention is suitable for driving inlet and exhaust valves. The only differences involved are in terms of dimensioning. Therefore, in the description hereinafter, when mention is made of valves, reference is made to inlet or exhaust valves of the internal combustion engine. The possible area of use of the variable valve drive according to the invention goes beyond pure use in relation to internal combustion engines. Further possible uses arise directly for active valve control in compressors and for actuating fast hydraulic valves.

In the valve drive according to the invention the valve is held in the closed position by hydraulic closing forces. In that way it is possible in a simple fashion to compensate for valve play which occurs due to wear and deposits on the valve.

In an embodiment according to the invention of a fully variable valve drive the control valve or valves is or are switched only when the hydraulic volume flow flowing therethrough is less than 20% of the maximum volume flow flowing therethrough. A particularly preferred embodiment provides that the control valve or valves is or are switched only when the hydraulic fluid volume flow flowing therethrough is less than 10% or less than 5% of the maximum volume flow flowing therethrough. In this embodiment the switching speed of the hydraulic valves is not as crucial as in the state of the art. In addition significantly less energy is converted into heat by throttle losses.

Basically this concept according to the invention involves a positioning drive which is characterised by the operational features described hereinafter. Positioning is effected in one operation. Various positions can be selected in advance. In regard to all forces to be overcome it is the acceleration force that dominates. That means that the energy recovery effect is significant. The time for the positioning procedure is substantially independent of the position selected. A high level of dynamics and as a result extremely short positioning times are achieved. Overall only slight losses occur with the valve drive according to the invention. The forces to be overcome in the positioning operation are precisely known in advance, otherwise there would be serious scatter effects in terms of position.

Further features and details of the present invention are apparent from the specific description hereinafter. In the drawing:

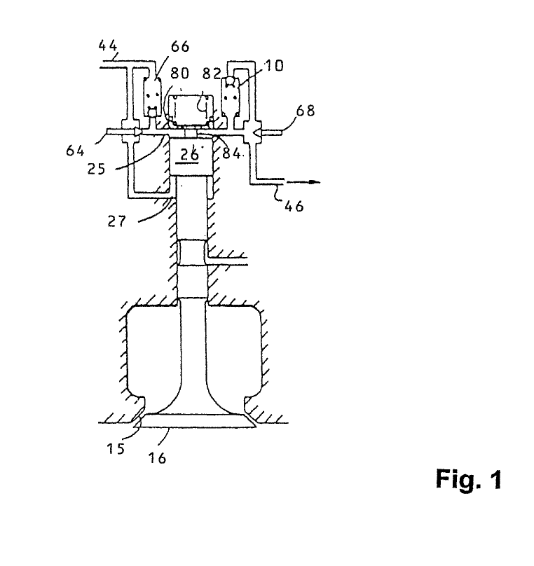

FIG. 1 shows the state of the art on the basis of a Ford patent,

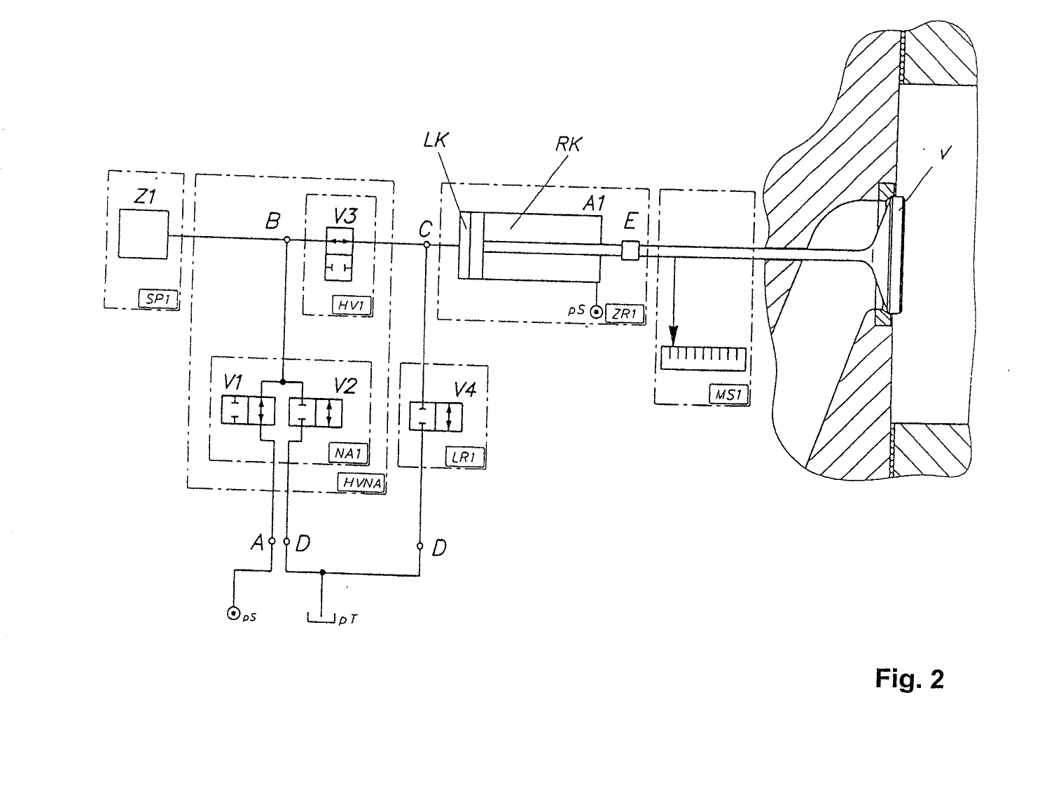

FIG. 2 shows an embodiment of the fully variable hydraulic valve drive according to the invention, and

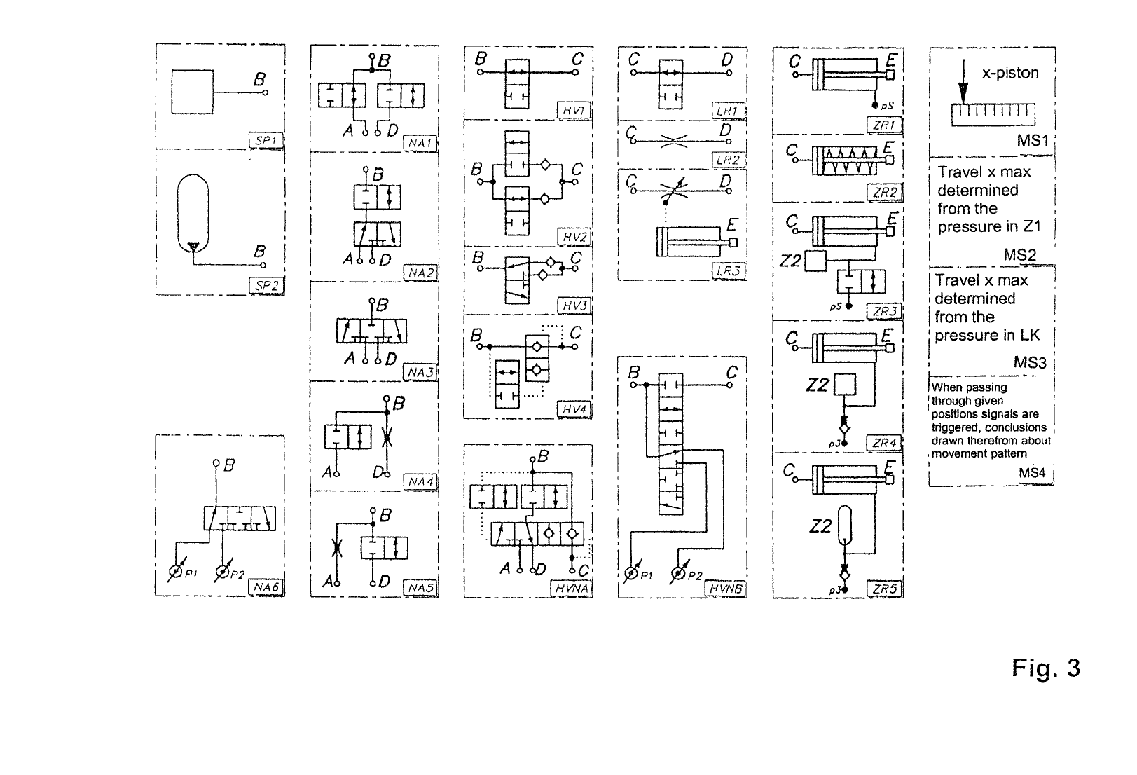

FIG. 3 shows variants of other preferred embodiments.

In the state of the art shown in FIG. 1 the inlet or exhaust valve are held in the closed position by a constant system pressure. The constant pressure (connection 44) acts in this case on the annular surface of the piston 26. By virtue of the control valve 64 opening, oil is pressed into the piston chamber 25 and the valve 16 is opened. After closure of the control valve 64 the valve 16 sucks in oil by way of the check valve 10 until the kinetic energy has died away. Thereafter the valve 16 stops in the opened position. To close the valve the control valve 68 is opened and the internal pressure discharged to the tank. The valve thus closes. Shortly before the valve meets the valve seat the control valve 68 is closed and the excess kinetic energy is fed back into the supply line in the form of an increased pressure in the fluid by way of the check valve 66.

In the hydraulic circuit diagram shown in FIG. 2 of a preferred embodiment of the valve drive according to the invention the hatched parts denote the cylinder walls, the cylinder head and the valve seat. The differential cylinder A1 is connected by way of its piston rod to the valve stem of the valve V. The cylinder chamber RK of the differential cylinder is connected by a line to the constant pressure pS. The volume Z1 forms a hydraulic capacitance. The three hydraulic valves V1, V2 and V3 (=control valves) are in the form of 2/2-port directional control valves and can be electrically actuated independently of each other. The 2/2-port directional control valve V4 (=control valve) connects the cylinder chamber LK of the differential cylinder to the tank line. The pressure obtaining in the supply line is pS, and the pressure pT gives the pressure prevailing in the return (tank line).

The operating principle of the fully variable valve drive according to the invention is described hereinafter. The cycle is subdivided into the following four portions: start condition, open valve, compensate for frictional losses and close valve. In the start condition the 2/2-port directional control valves V1. V2 and V4 (=control valves) are closed. The reference pressure pZ (=filling pressure) prevails in the hydraulic capacitance Z1 (=intermediate storage means). The piston of the differential cylinder is in the retracted condition near its mechanical limit position, the valve V is closed. The 2/2-port directional control valve V4 is opened so that the leakages which occur can flow away unimpeded into the tank and no unwanted pressure is built up in the left-hand cylinder chamber LK. The supply pressure pS obtains in the right-hand cylinder chamber RK. That causes a constant force F which presses the valve V against the valve seat.

In order to open the valve V the 2/2-port directional control valve V4 must be closed and the valve V3 must be opened. The piston of the differential cylinder is accelerated because a part of the compressed hydraulic fluid flows across from the hydraulic capacitance Z1 into the differential cylinder. That flow is concluded when the piston of the cylinder has reached the reversal point (piston speed becomes zero). The 2/2-port directional control valve V4 is closed again so that the valve V remains open.

In the friction-free situation the piston would move back again into the starting position when the 2/2-port directional control valve V3 is opened again. In order to compensate for the losses due to friction and leakages, oil from the volume Z1 is let off in the open condition of the valve V by way of the 2/2-port directional control valve V2. The pressure in Z1 is thereby reduced to the let-off or dump pressure pZA.

So that the valve V is closed the 2/2-port directional control valve V3 is opened. The piston is accelerated jointly with the valve V as a consequence of the hydraulic pressure pS operative in the cylinder chamber RK. That movement continues until the spacing between the valve V and the valve seat has reached a very small predetermined value. In that situation the kinetic energy of the valve V is stored again in the hydraulic capacitance Z1. The 2/2-port directional control valve V3 is closed again when the piston stops. So that the valve V is completely closed the 2/2-port directional control valve V4 must be opened. In that way also once again leakages which occur in the components used are passed into the tank so as to ensure that the valve V is certain to close. The pressure which obtains at that time in the hydraulic capacitance Z1 is too low for a fresh cycle because losses have occurred. For that reason the 2/2-port directional control valve V1 is opened until the desired reference pressure pZ is reached again. When the 2/2-port directional control valve V1 has closed the start condition has been reached again. Control of the stroke movement of the valve V can be achieved by a variation in the pressure in the start condition pZ. If the pressure is increased there is more stored energy in the prestressed volume Z1 and as a result the valve V is opened wider. For a short stroke movement it is only necessary to reduce the start pressure. As this involves a cyclic process the pressure can be easily set by varying the opening time of the 2/2-port directional control valve V1.

The moment in time of opening of the valve can be easily controlled by the valve V3. If the hydraulic valve is never opened then the valve V is not opened and in that way each valve V and thus each individual cylinder of the engine can be shut down for a given time (idle mode, part-load mode). If the valve V is opened then the valve V can be closed again at any time by renewed opening of the hydraulic valve V3.

Besides this preferred embodiment of the valve drive according to the invention, FIG. 3 shows further possible embodiments according to the invention. When a variant is incorporated into the variable valve drive as shown in FIG. 2, consideration must be given to the nodes A, B, C, D and E. It is only ever identically identified nodes that may be connected together.

Variants of the storage block SP are discussed hereinafter: Shown in SP1 is a hydraulic capacitance, that is to say a cavity filled with hydraulic fluid, of the constant volume V1. The variant SP2 is formed from a current, gas-filled hydraulic storage means. In this respect all three kinds (diaphragm storage means, balloon storage means and piston storage means) are suitable.

The variants of the refilling and let-off block NA are discussed hereinafter: NA1 comprises two 2/2-port directional control valves. They are controllable independently of each other. Variant NA2 comprises a 2/2-port directional control valve and a 3/2-port directional valve. The two valves can be actuated separately from each other. NA3 comprises a 3/3-port directional control valve which in a switching position can entirely close the connections A, B and D. NA4 comprises a 2/2-port directional control valve connected to the pressure connection and a throttle connected to the tank connection. NA5 comprises a 2/2port directional control valve connected to the tank connection and a throttle connected to the pressure connection. NA6 comprises a 3/3port directional control valve, the same is also used in NA3. The pressures p1 and p2 in the two supply lines can be steplessly adjusted as desired independently of each other.

As variants of the main valve—block HV, besides HV1 which comprises a 2/2-port directional control valve, variant HV2 is also shown in FIG. 3. Here the block HV comprises in each case two 2/2port directional control valves and check valves. Actuation of the valves is effected independently of each other. The function of the two check valves is described in the description of variant HV4. The variant HV3 provides that the block HV comprises a 3/2-port directional control valve and two check valves. The function of the two check valves is also described in the description of the variant HV4. The variant HV4 provides that the block HV comprises a 2/2-port directional control valve and a 3/2-port directional control valve with two integrated check valves. The control spool of the 3/2-port directional control valve is controlled with the 2/2port directional control valve. The check valve which is respectively used closes automatically when the piston of the differential cylinder changes its direction of movement and as a result the flow direction through the check valve which is respectively in use is also reversed. The piston remains in its position until the control spool of the 3/2-port directional control valve is switched over into the upper position. The hydraulic fluid required for pilot control of the control spool is taken from the node B or C, depending on the respective direction of movement of the control spool. With this kind of pilot control, the same amount of hydraulic fluid is displaced at the other end of the control spool, which had to be supplied at the one side. The displaced hydraulic fluid is fed to the node C or B and is further available for acceleration of the piston. Before the pressure in the node C or B becomes greater than that in the node B or C (reversal point), the 2/2-port directional control valve has to be closed. That prevents the control spool from switching over when that is not wanted. If the cycle is to be further continued the 2/2-port directional control valve has to be briefly opened again.

Variants of the main valve and the refilling-let-off block HVNA are described hereinafter. This block can be used instead of the blocks NA and HV. A 5/4-port directional control valve with two incorporated check valves is pilot-controlled by a 2/2-port directional control valve. The mode of operation involved is the same as in the case of the valve block HV4 and was described there. The other part of the valve is the same as the valve concept described in relation to NA2. The control spools of the two 3/2-port directional control valves are coupled together mechanically (or also only hydraulically) and controlled by the 2/2-port directional control valve. The principle of the pilot control action was also already described in relation to HV4.

A variant of HVNA is HVNB. HVNB is formed from two different directional control valves. One is a 3/3-port directional control valve which controls the feed flow and the discharge flow in the node B and the other is a 3/2-port directional control valve which permits fluid to flow across between the nodes B and C. The control spools of the two above-described directional control valves are connected together and thus combined to form one control spool. That provides for simultaneous actuation which substantially simplifies control of the system. The pressures p1 and p2 of the two supply lines can be steplessly adjusted as desired independently of each other, as in NA6.

Variants of the leakage oil return block LR are discussed hereinafter. LR1 comprises only a 2/2-port directional control valve. LR2 comprises only a throttle of constant cross-section. In the case of the throttle indicated at LR3 the hydraulic resistance of the throttle is dependent on the position of the piston of the differential cylinder. The resistance should be low when the piston is retracted. When the piston leaves its end position (piston is entirely retracted) and goes beyond a certain boundary the throttle should be completely closed.

Variants of the cylinder with a return device ZR are discussed hereinafter. In ZR the cylinder is in the form of a differential cylinder. The constant system pressure pS always obtains in the cylinder chamber on the side of the annular surface. In ZR2 the cylinder is in the form of a single-acting cylinder (plunger cylinder) with spring return. In ZR3 the cylinder is in the form of a differential cylinder. A hydraulic capacitance Z2 and a 2/2-port directional control valve are also used. The oil losses which occur because of leakage can be compensated when the 2/2-port directional control valve is opened. In ZR4 the cylinder is in the form of a differential cylinder. A hydraulic capacitance Z2 and a check valve are also used. The check valve opens when the pressure in the hydraulic capacitance Z2 falls below the supply pressure p1. Leakages are compensated in that way. The variant ZR5, except for the hydraulic capacitance, is the same as that which was described in relation to ZR4. Instead of the hydraulic capacitance a hydraulic storage means Z2 is used. The use of a hydraulic storage means instead of the hydraulic capacitance Z2 is also a possibility in the variant ZR3. In general terms all three kinds (diaphragm storage means, balloon storage means and piston storage means) are suitable in regard to the configuration of the hydraulic storage means Z2. A gas can also be used as the medium in the variants ZR1, ZR4 and ZR5. A gas pressure can be involved in the variant ZR2 in addition to the spring.

Regulation and control measures are discussed hereinafter. The method presented is essentially based on a control action. In principle it is sufficient to set the correct pressure pZ in the storage means Z1 for the respectively desired opening stroke movement of the valve V. The setting values can be stored for example in dependence on various influencing parameters (temperature of the oil and in the cylinder head, boost condition, . . . ) in the form of characteristic curves. If the level of accuracy which can be achieved in that way should not suffice, an improvement can be achieved, in connection with suitable regulation, by measurement of the position of the valve V or any other member fixedly connected thereto.

Measurements of the position involved can be effected in various ways. A travel sensor MS1 operating on the basis of a familiar principle (inductively, optically, capacitively,. . .) continuously measures the current position of the valve. Alternatively it is possible to use a pressure pick-up (pressure sensor) in the capacitance Z1-MS2. With a given filling pressure in the hydraulic capacitance Z1, in both variants SP1 and SP2 there is a unique relationship between the position of the valve V and the pressure in Z1. In addition that pressure signal can also be used for setting the filling pressure pZ or the let-off pressure pZA. Alternatively to MS2 it is also possible to use MS3. Here a pressure pick-up (pressure sensor) is arranged in the cylinder chamber LK. In the opened position of the valve V3 the pressure in LK is substantially equal to the pressure in Z1 and can therefore equally be used for measurement of the position of the valve V. Pressure measurement for determining the position of the valve V can additionally also be implemented in the intermediate storage means Z1 and in the storage means Z2. As an alternative to the above-discussed variants, the variant MS4 shows a possible way of effecting measurement at given positions of the valve V. During the positioning operation signals are triggered at given positions of the valve V. It is possible to draw therefrom conclusions relating to the pattern of movement, in particular the end position attained. Such signals can be triggered for example by inductive or capacitive proximity switches or by light barrier assemblies.

In regard to the regulating methods, correction of the filling pressure pZ in Z1 is to be listed first. By ongoing observation of the end position reached, the setting values for the filling pressure in Z1 are re-adjusted in such a way that the desired position is reached with the required level of accuracy. That can be effected for example by a variation in the opening time of the valve V1. Correction of the let-off pressure pZA in Z1 is effected as follows. By observing the variation in position of the valve V in the closing phase it is possible to re-adjust the setting value for the let-off pressure pZA. In the variant HVNB and NA6 the two pressures are regulated jointly for an entire engine.

1. A fully variable hydraulic valve drive comprising a hydraulic drive unit which is acted upon with hydraulic fluid for opening and closing a valve wherein the drive unit of the valve in the closing or opening stroke movement acts on an intermediate storage means with hydraulic fluid under pressure, wherein this hydraulic fluid which is stored under pressure in the intermediate storage means then drives the drive unit of the valve again in the opposite stroke movement.

2. A valve drive as set forth in claim 1 wherein the valve is accelerated and decelerated in the opening or in the closing stroke movement or in both stroke movements in the form of a free oscillator.

3. A valve drive as set forth in claim 2 wherein a control valve holds the valve fast in the opened and closed condition.

4. A valve drive as set forth in claim 1 wherein an opening or a closing stroke movement or both movements of the valve is or are effected in a hydraulic system which is closed in that time interval and which comprises an intermediate storage means, a drive unit of the valve, and a control valve.

5. A valve drive as set forth in claim 1 wherein the valve drive drives inlet or exhaust valves or both types of valves.

6. A valve drive as set forth in claim 1 wherein the stroke travel of the valve is adjustable.

7. A valve drive as set forth in claim 1 wherein compensation for the losses caused by friction and leakage is effected by make-up supply of pressurised hydraulic fluid from a supply line.

8. A valve drive as set forth in claim 1 wherein the opening and closing moment of the valve is freely controllable.

9. A valve drive as set forth in claim 1 wherein the stroke movement of the valve is controlled by the filling pressure obtaining in the intermediate storage means in the closed condition of the valve.

10. A valve drive as set forth in claim 1 wherein the opening time of a control valve regulates the filling pressure of the intermediate storage means in the closed condition of the valve.

11. A valve drive as set forth in claim 1 wherein the setting values are stored in dependence on various influencing parameters.

12. A valve drive as set forth in claim 11 wherein the influencing parameter is the temperature of the oil or the temperature of the cylinder head or the boost condition or a combination thereof.

13. A valve drive as set forth in claim 1 wherein when the valve is closed filling pressure obtains in the intermediate storage means.

14. A valve drive as set forth in claim 1 wherein the valve is opened by means of the filling pressure obtaining in the intermediate storage means.

15. A valve drive as set forth in claim 1 wherein the drive unit of the valve is in the form of a differential cylinder.

16. A valve drive as set forth in claim 15 wherein the supply pressure obtains in the right-hand cylinder chamber of the differential cylinder.

17. A valve drive as set forth in claim 1 wherein the drive unit of the valve is in the form of a cylinder with a spring return or in the form of a plunger cylinder.

18. A valve drive as set forth in claim 1 wherein the intermediate storage means is in the form of a volume representing a hydraulic capacitance.

19. A valve drive as set forth in claim 1 wherein the storage means is in the form of a volume representing a hydraulic capacitance.

20. A valve drive as set forth in claim 1 wherein the intermediate storage means is in the form of a gas-filled hydraulic storage means or in the form of a diaphragm or a balloon or a piston storage means or in the form of a combination thereof.

21. A valve drive as set forth in claim 1 wherein the storage means is in the form of a gas-filled hydraulic storage means or in the form of a diaphragm or a balloon or a piston storage means or in the form of a combination thereof.

22. A valve drive as set forth in claim 1 wherein measurement of the position of the engine valve is effected inductively or optically or capacitively or by pressure measurement in the intermediate storage means or in the storage means or in the chamber.

23. A valve drive as set forth in claim 1 wherein a pressure pick-up measures the pressure obtaining in the intermediate storage means or the storage means or in the chamber.

24. A valve drive as set forth in claim 1 wherein the hydraulic drive unit is a piston cylinder unit.

25. A valve drive as set forth in claim 1 wherein the valve drive is acted upon with hydraulic fluid for opening and closing a valve of an internal combustion engine.

26. A fully variable hydraulic valve drive comprising at least one control valve and a hydraulic drive unit which is acted upon with hydraulic fluid for opening and closing a valve wherein the drive unit of the valve in the closing or opening stroke movement acts on an intermediate storage means with hydraulic fluid under pressure wherein the control valve or valves is or are switched only when the hydraulic fluid volume flow flowing therethrough is less than 20% of the maximum volume flow flowing therethrough.

27. A valve drive as set forth in claim 26 characterised in that the control valve or valves is or are switched only when the hydraulic fluid volume flow flowing therethrough is less than 10% of the maximum volume flow flowing therethrough.

28. A valve drive as set forth in claim 26 wherein when the valve is closed filling pressure obtains in the intermediate storage means.

29. A valve drive as set forth in claim 26 wherein the valve is opened by means of the filling pressure obtaining in the intermediate storage means.

30. A valve drive as set forth in claim 26 wherein the drive unit of the valve is in the form of a differential cylinder.

31. A valve drive as set forth in claim 30 wherein the supply pressure obtains in the right-hand cylinder chamber of the differential cylinder.

32. A valve drive as set forth in claim 26 wherein the drive unit of the valve is in the form of a cylinder with a spring return or in the form of a plunger cylinder.

33. A valve drive as set forth in claim 26 wherein the intermediate storage means is in the form of a volume representing a hydraulic capacitance.

34. A valve drive as set forth in claim 26 wherein the storage means is in the form of a volume representing a hydraulic capacitance.

35. A valve drive as set forth in claim 26 wherein the intermediate storage means is in the form of a gas-filled hydraulic storage means or in the form of a diaphragm or a balloon or a piston storage means or in the form of a combination thereof.

36. A valve drive as set forth in claim 26 wherein the storage means is in the form of a gas-filled hydraulic storage means or in the form of a diaphragm or a balloon or a piston storage means or in the form of a combination thereof.

37. A valve drive as set forth in claim 26 wherein measurement of the position of the engine valve is effected inductively or optically or capacitively or by pressure measurement in the intermediate storage means or in the storage means or in the chamber.

38. A valve drive as set forth in claim 26 wherein a pressure pick-up measures the pressure obtaining in the intermediate storage means or the storage means or in the chamber.

39. A valve drive as set forth in claim 26 wherein the hydraulic unit is a piston cylinder unit.

40. A valve drive as set forth in claim 26 wherein the valve drive is acted upon with hydraulic fluid for opening and closing a valve of an internal combustion engine.
